(19) United States
(12) Patent Application Publication
(10) Pub. No.: US 2007/0061143 A1
(43) Pub. Date: Mar. 15, 2007

(54) Method for collating words based on the words' syllables, and phonetic symbols

(76) Inventor: Mark Jonathan Wilson, N. Potomac, MD (US)

Correspondence Address: MARK J. WILSON, 10540 SMITH CT., N. POTOMAC, MD, 20878, US

(21) Appl. No.: 11/225,717

(22) Filed: Sep. 14, 2005

(51) Int. Cl. G10L 15/00

(52) U.S. Cl. 704/252

(57) ABSTRACT

This invention is the method of collating words of Indo-European languages by using a special mark for the space between syllables and the languages' phonetic symbols, to produce word lists in which the listed words' articulations of syllables and phonemes are arranged sequentially as close to each other phonetically as possible. While most word list are arranged alphabetic based on an order of letters and the number of letters used in the languages' spelling system, this method would arrange word list based on an order of marks & symbols, and the number of unique sounds used in the languages' pronunciation system. The stark contrast is the alphabetic system results in word list with words arranged as close to each other spelling wise as can be, however this invention's method results in word list with word arranged as close to each other sound wise as can be.

### BACKGROUND OF THE INVENTION

1. Field of the Invention

This invention relates to the method of collating words using phonetic symbols, to produce word lists in which the listed words' articulations of syllables and phonemes are arranged sequentially as close to each other phonetically as possible.

2. Background Art

Beginning several centuries ago, publishers have produced and sold dictionaries to the public. These dictionaries placed the word entries in alphabetic order and provided information: definition, grammar, pronunciation, origin. The dictionaries' primary purpose has been to aid in selecting the best word for the thought with its correct spelling.

Dictionaries are a great aid in the effort to pronounce new words or to correct speaking errors. The way dictionaries do this is to provide phonic symbols for each sound used in the word. In simple languages like Spanish the spelling symbols—the alphabet—matches the phonic symbols. In complex languages such as English the spelling symbols number 26 while the language uses a minimum of 43 phonic symbols to represent the individual sounds. Some languages over the centuries have increased their spelling symbols such as the Danish which went from 26 to 29.

Dictionaries' words are arranged in alphabetic order because the books are used primarily as an aid to written language usage as opposed to the auditory language usage. Therefore the dictionaries word order is based on the use of spelling symbols and not phonic symbols, and this leads to two problems. Because in some languages the sheer number of possible spellings of individual phonic sounds making it difficult to spell a word correctly in the situation where one has never seen the word before and yet has to write the word based on its pronunciation. In vowel transposition in English for example, the short vowel sound i has ten spelling forms: i, e, o, u, y, ee, e, e i., ie, and ui. Another difficult area when looking up a word, to one with limited visual experience in English, is the silent first letter of a word like the “k” in know, or the “p” in psychiatry. Needless to say, without knowledge of the spelling of “know” or “psychiatry” one would find it hard to locate these words in a present day dictionary.

Presently, with use of computers, digital machines, computer programs and software, society has developed digital dictionaries and digital spell checkers. Together, these developments have provided the data bases or large lexicons and the means to mine the data for spelling options. In doing so, methods have been made to sort through the letter-sound correspondence of a given language orthography. Yet again, the methods center on finding the most probable spelling correction. My invention provides the means to list words by a languages' pronunciation. Printing word listings by pronunciations has the advantage of arranging words so one can understand the cause and effect-relationships—of individual sounds, combinations of sounds, blended sounds, syllable sounds and word sounds to the written word. In English for example, the dynamic of approximately 40 sounds represented and shared by 26 writing characters, with those characters and character combinations making up to nearly 400 graphic representations of the 40 sounds is complex orthographic interplay of phonemes and graphemes to say the least.

### SUMMARY OF THE INVENTION

This invention is the method of collating words of Indo-European languages by using a special mark for the space between syllables and the languages' phonetic symbols, to produce word lists in which the listed words' articulations of syllables and phonemes are arranged sequentially as close to each other phonetically as possible. While most word list are arranged alphabetic based on an order of letters and the number of letters used in the languages' spelling system, this method would arrange word list based on an order of marks & symbols, of the number of unique sounds used in the languages' pronunciation system. The stark contrast is the alphabetic system results in word list with words arranged as close to each other spelling wise as can be, however this invention's method results in word list with word arranged as close to each other sound wise as can be.

### DESCRIPTION OF FIGURES

FIG. 1. Is an Accounting Chart emphasizing the many possible sub chapters a dictionary type book could have of a language when one organizing the book around first two sound of a language's words. English language is used in this example.

FIG. 2. Is this display of the contrast between two list of the same words, with one list displaying the phonetic version of the word, while the other list displaying the orthographic version, one see advantage of a phonetic order for the purpose of alining like sounding words together, an example of the number of like sound words that could be found. A sample of 59 English words is used in this display.

FIG. 3. In this display one see the inherence distance in a dictionary word list between the same phonetic words placed in alphabetic order. In this English example some 17 alphabetizes words lay between the two words. The invention method eliminates the in between word by re-collating phonetically.

FIG. 4. This listing shows for example a possible English language's order of marks and phonetic symbols, numerical values of those marks and symbols, and what the marks and symbols represent of the language.

FIG. 5. This display shows the schematic workings of a group of collating string character values for computer collating. With assigned numerical values to a language's marks and phonetic symbols of the language's words, a computer program system can be directed to collate the word's values, store the results and display the results.

### DETAIL DESCRIPTION OF THE INVENTION

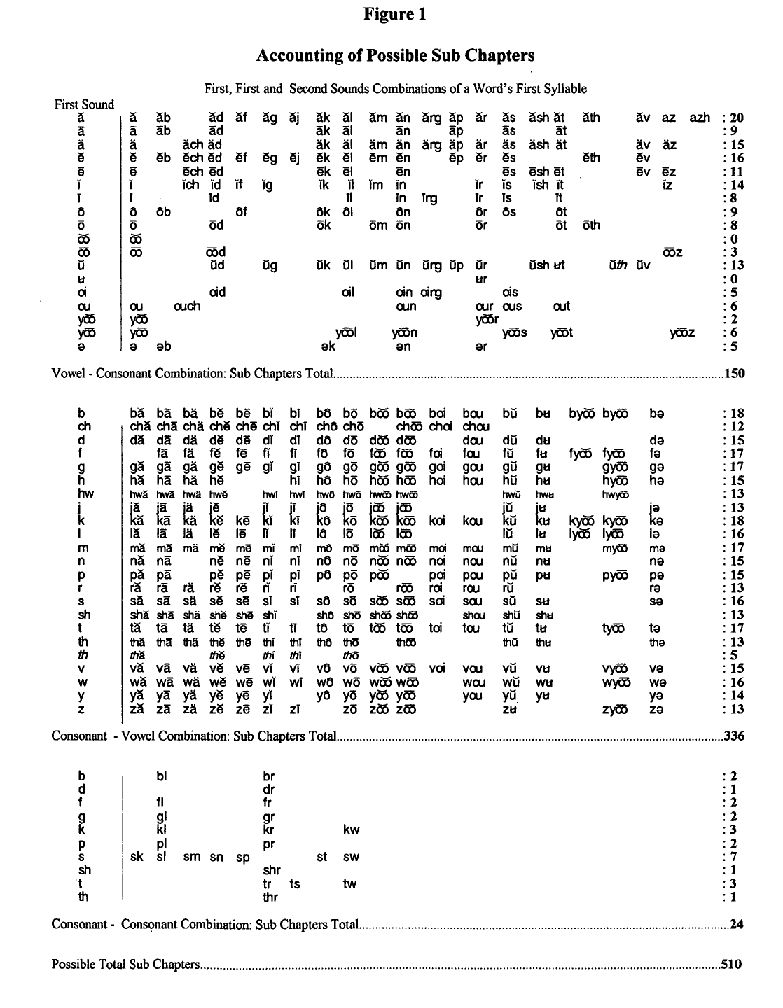

In using my design invention an English dictionary for an example would organize words collating and listing them by phonetic symbols, dividing them into about 43 chapter one for each English sound instead of the usual dictionary format of a chapter by each letter. Furthermore, each chapter could be subdivided, according to words beginning with one of the 18 vowel sounds in the vowel chapters and the next sub-chapters would be the listing of any of the possible 25 accompanying consonants in the second character position. Likewise, in the 25 consonant chapters, the sub-chapter could number 18, one for each accompanying vowel. In a number of many cases there would be no first word existing for some of those sub-chapter phoneme combinations. See FIG. 1.

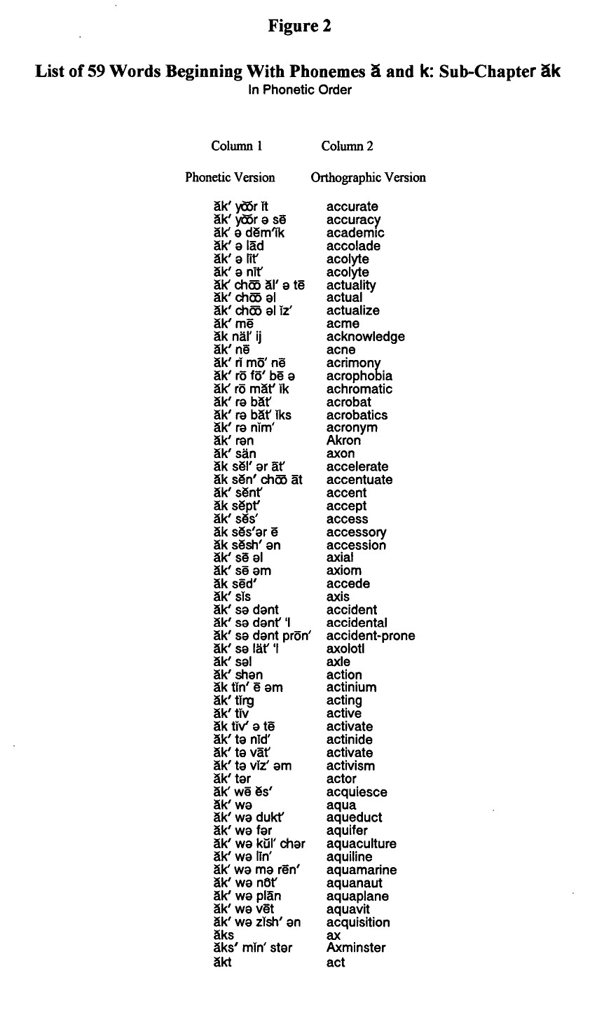

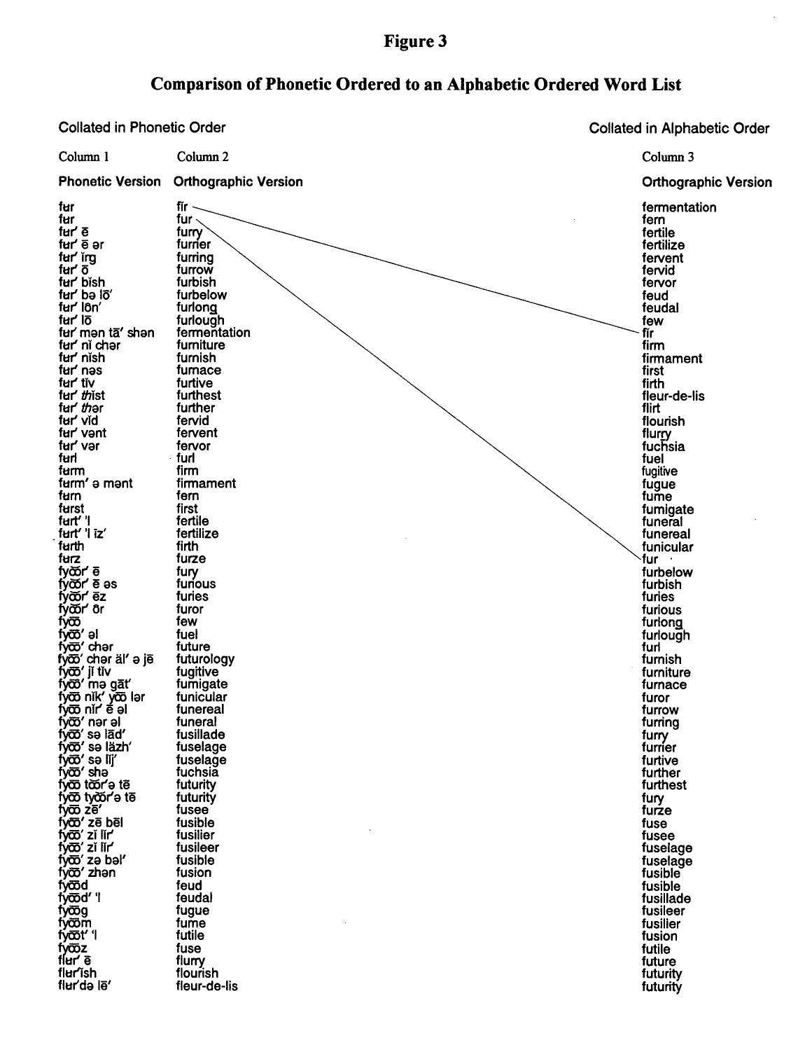

To locate a word one would first focus on a word's first two sounds narrowing the search to one of the 43 chapters, and then narrow it again to either 18 or 25 sub-chapters. The point is that within those sub-chapters one will find the closest like sound words grouped together, and thus come upon a vast expanded pronunciation key. Where the typical pronunciation key in a dictionary has one to three examples of words using a particular phoneme, this invention would maximize the listing examples to the limit of the words in the total data base. A modest 30,000 word list will generate many more than three examples of words beginning with phonemes äk. (See FIG. 2 for an example) Conversely the design invention eliminates the many words around the one search word whom share the first vowel character but not the same vowel sound. (See FIG. 3 and compare the number of words between the listing of words fir and fur in column 3 to columns 1 and 2.) Furthermore, to guide one in locating the correct spelling this arrangement of phonetic listings forces one to focus on pronunciation and hearing. And practicing those two skills is paramount to improving speech, comprehension and spelling skills.

So to improve the auditory learning and spelling of specifically Indo-European languages I have developed a method of collating words, which insures the closest ordering possible of like sounding words (and syllables) for a given language and given number of words. The method of collating words is done by comparing the words' phonic symbols and syllabication.

The Method of Collating Words With Phonetic Symbols

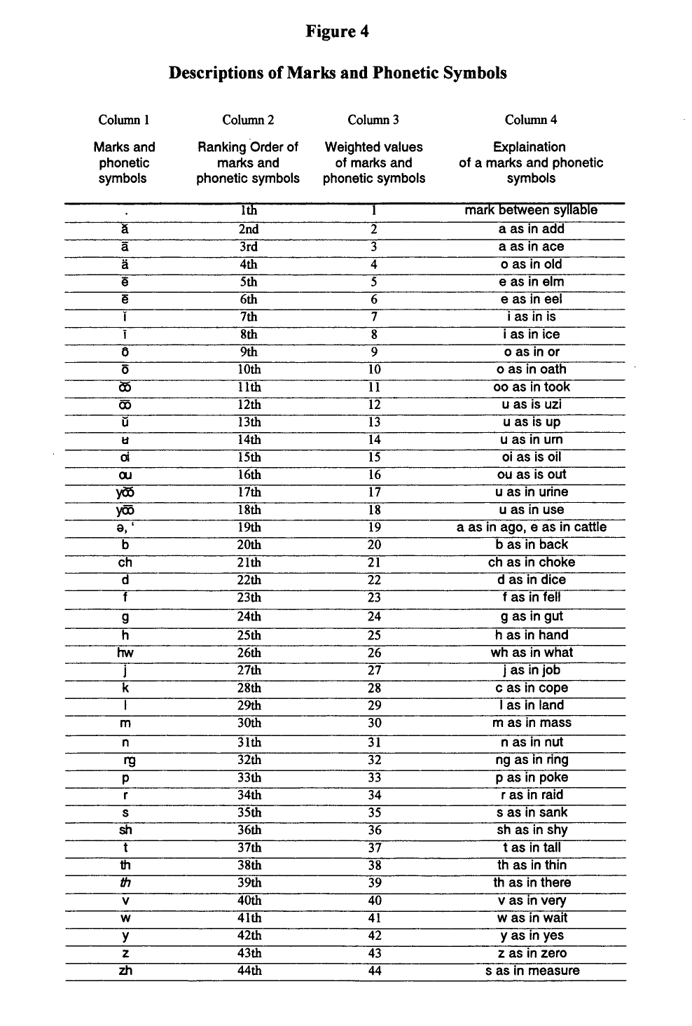

The first step, is to assign phonetic symbols to represent each sound of a language that one would hear or distinguish. See FIG. 4, columns 1 and 4 for an example of 43 phonetic symbols and one special mark which could be used for sounding American English. The special mark “.” is used to show a break between syllables. Accents of syllables are ignored.

Step two, is to assign a rank and a weight to the chosen mark and phonetic symbols in this order: (1) the special mark representing the space between syllables; (2) the vowel, diphthong sounds and semi-vowels; (3) consonant sounds. An example for the English language would be: \check{a}, a̅, ä, \check{e}, e̅, \check{i}, i̅, ô, o̅, [symbol] , o̅o̅, oi, ou, \check{u}, /u, y [symbol] , y o̅o̅, [symbol] ′, b, ch, d, f, g, h, hw, j, k, l, m, n, rg, p, r, s, sh, t, th, th, v, w, y, z, zh with “.” being ranked first with a weighted valve of 1 and zh being ranked 44^{th} with a weight 44. See FIG. 4 columns 1, 2, and 3.

Step three, is to gather together the number of words of a single language, in typographical form into a data base, that one wishes to place in phonetic word order, with both the individual words', phonetic and orthographic version paired together. See FIG. 3 columns 1 and 2 for examples of pairing versions.

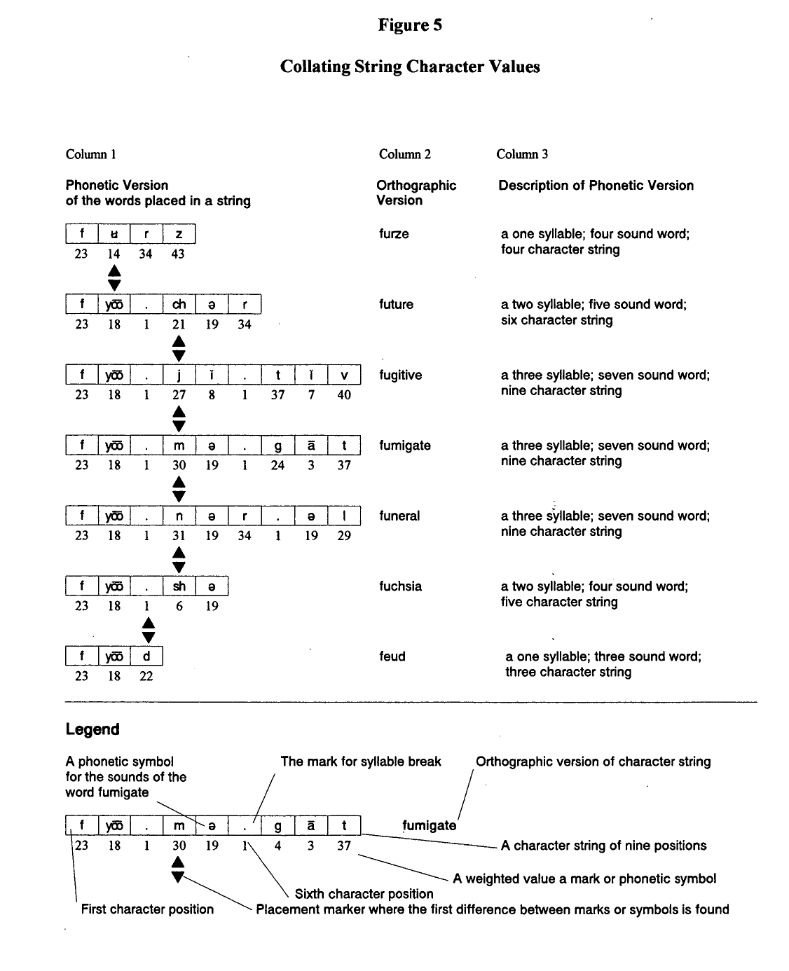

Step four, involves collating all the words' phonetic symbols either by: (1) hand collating by human intuition comparing by ranking; (2) machine collating with the aid of a computer program that uses a string comparison function with variable mark and phonetic symbols weights. Collating begins by comparing two words' phonetic symbols. One first does so by comparing the string of phonetic symbols with the same position in each word, beginning with the first phonetic symbol position on the left side in the words. In comparing, one is looking for the first difference or first non-matching sequential phonetic symbols. Once the difference of phonetic symbols is found the ranking or phonetic symbol's weight of those mismatched symbols determines the order between the words, regardless of the remaining symbols to the right-hand side. See FIG. 3 where some sixty words were hand collated from alphabetic order (column 3) to phonetic order (column 1). See FIG. 5 where for example the words feud, fuchsia, fugitive, fumigate, funeral, furze, and future were collated by weights.

Step five, is to display the results of the collating either with an electronic machine display, printed version or published manuscript. For an example see FIG. 3 columns 1 and 2.

What is claimed is:

1. The method of performing the collating of a plurality of words of a languages according to their phonemes, and listing the words in both phonetic symbols and conventional spelling symbols, said method comprising the steps of:
assigning phonetic symbols to represent each sound (phoneme) of a said language; assigning one special mark to represent the space that occurs between syllables of a said language; ignoring any accent sound symbols of a said language; assigning an ranking order and weighted values to all the marks and phonetic symbols by: assigning the mark for the space between syllables to be ranked first and the lowest weighted value; assigning vowels, diphthongs and semi-vowels phonemes the next available ranks and weights following the mark assigned for the space between syllables; assigning consonants and semi-consonants phonemes ranks and weights following the assigned phonetic symbol for vowels, diphthongs and semi-vowels phonemes; searching the dictionary or other sources for the syllabification of said plurality of words and phonetic symbols of the phonemes associated with the pronunciation of said plurality of words; recording each said word and their phonetic symbols in either a digit format or typed format or hand written format;
collating through all the words' marks and phonetic symbols by hand; collating is comparing each words' first phonetic symbols beginning from left to right and then the next adjacent mark or phonetic symbol to the right in each word and so on until one finds the first difference or first non-match between the two words' marks or phonetic symbols; the ranking order of those mismatched mark or phonetic symbols determines the order between the words, regardless of the remaining marks or phonetic symbols; all mark and phonetic symbols are listed in rank with the highest ranking mark or symbol being listed first of order; displaying the results of the collation either with an electronic machine display, published version, handwritten version, published manuscript, or auditory version;
collating through all the words' marks and phonetic symbols by an electronic machine processor of a string function with variable phonetic symbols weights; collated is comparing each words' strings' of marks and phonetic symbols representing the string's characters, beginning with the first pair of phonetic symbols then proceeding to the right hand to the next pair of marks or phonetic symbols at the same next string positions in each string and so on until; one finds the first difference or first non-match between marks or phonetic symbols; the mark or phonetic symbols' weight of those mismatched phonetic symbols determines the order between the two strings, regardless of the remaining marks or phonetic symbols; all marks and phonetic symbols are listed in weighted values with the lowest weight symbol being listed first; displaying the results of the collating either with a electronic machine display, printed version, handwritten version, published manuscript or auditory version;

2. The method of claim 1, pertains to all Indo-European languages that can be syllabized;

3. The method of claim 1, pertains to all published, electronically and auditory produced word ordered listings;

4. The method of clam 1, uses phonetic symbols to represent the said languages' individual and blended sounds;

5. The method of claim 1, uses ranking order assigned to said languages' marks and phonetic symbols;

6. The method of claim 1, the one “mark” used to represent the end of one syllable and the beginning of another syllable of a said words is assigns the rank of 1^{st};

7. The method of claim 1, the ranking of 1^{st} mark or phonetic symbol is collated ahead of the ranking of the 2^{nd} mark or phonetic symbol and so forth;

8. The method of claim 1, uses weighted values assigned to languages' marks and phonetic symbols;

9. The method of claim 1, the one “mark” used to represent the end of one syllable and the beginning of another syllable of a said words is assigns the weighted value of 1;

10. The method of claim 1, the weighted value of 1 for the mark or phonetic symbols is collated ahead of the weighted value of 2 for a mark or phonetic symbol and so forth;

10. The method of claim 1, there is no mark or phonetic symbol placed collated ahead of either the rank of 1^{st}, or the weighted value of 1;

11. The method of claim 1 in the ranking order and weighted values of marks and phonetic symbols, one ignores any accent symbols for a syllable of a said language;
